(19) United States
(12) Patent Application Publication
(10) Pub. No.: US 2007/0162583 A1
(43) Pub. Date: Jul. 12, 2007

(54) Information providing device, device discovering method, and computer product

(75) Inventors: Satoru Takahashi, Kawasaki (JP); Hiroki Ichiki, Kawasaki (JP); Takao Mohri, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/400,291

(22) Filed: Apr. 10, 2006

(30) Foreign Application Priority Data
Jan. 11, 2006 (JP) 2006-004097

(51) Int. Cl. G06F 15/173

(52) U.S. Cl. 709/223

(57) ABSTRACT

A first device, a second device, and a plurality of third devices are connected to one network. The second device holds attribute information of all the third devices. The first device sends a discovery request of a UPnP protocol. The discovery request includes a service type corresponding to the device-information providing service realized by the second device. When the second device receives the discovery request, it responds by sending back information indicative of the device-information providing service. When the first device receives the response from the second device, it understands the presence of the second device in the network, and sends an information demanding request for demanding attribute information of the third devices. In response, the second device sends the attribute information of the third devices to the first device.

### BACKGROUND OF THE INVENTION

1. Field of the Invention

The present invention relates to a technology by which a device connected to a network discovers another device connected to the same network.

2. Description of the Related Art

Recently, Universal Plug and Play (UPnP) has been attracting attention as a technology for automatically discovering various devices on a network. A typical UPnP-enabled device includes a UPnP device and a function of UPnP service, and responds to a multicast discovery request by returning information relating to at least one of the UPnP device and the UPnP service. Moreover, upon receiving a request, the UPnP-enabled device transmits a state variable stored by the UPnP service and executes an action relating to the UPnP service.

An information processing unit, such as a personal computer, can be configured to employ such a technique to discover a device present on the network to which the information processing unit is connected as well as obtain detailed attribute information and execute various operations by remote control. Japanese Patent Publication No. 2003-6133 discloses a technology in which an information processing unit automatically discovers a printer on the same network as the information processing unit by using UPnP, and automatically installs a driver software corresponding to the discovered printer.

However, UPnP has a drawback that a requestor cannot freely set discovering conditions. Specifically, when searching for a UPnP device or a UPnP service corresponding to a desired type information, conventionally, type information can be set as the discovering condition. Alternatively, when searching for a UPnP device or a UPnP service at random, conventionally, no discovering condition is set.

Accordingly, if a lot of devices exist on the network, because there is only one or no discovering condition, many devices match with the discovering condition and all of them respond to the request, which puts a heavy load on the requester and the network.

One approach could be to use some technology other than the UPnP; however, because UPnP is becoming widespread in this field, adoption of a different technology will certainly narrow the range of choice of available device, moreover, there may occur frequent failures due to lack of compatibility between devices.

### SUMMARY OF THE INVENTION

It is an object of the present invention to at least partially solve the problems in the conventional technology.

According to an aspect of the present invention, an information providing device that realizes a device-information providing service of providing, as a UPnP service, attribute information of a first device to a second device, wherein the information providing device, the first device, and the second device being connected to one network, includes a storage unit that stores therein the attribute information of the first device; a presence expressing unit that, when the second device transmits in the network a discovery request of a UPnP protocol that specifies a service type corresponding to the device-information providing service, reports presence of the information processing device in the network by sending information related to the device-information providing service to the second device via the network; and an attribute-information sending unit that, when the second device sends in the network an information demanding request for demanding the attribute information of the first device, sends the attribute information of the first device in the storage unit to the second device.

According to another aspect of the present invention, a computer-readable recording medium that stores therein a computer program that causes an information providing device to realizes a device-information providing service of providing, as a UPnP service, attribute information of a first device to a second device, wherein the information providing device, the first device, and the second device being connected to one network, wherein the computer program causes the information providing device to execute reporting presence of the information processing device in the network, when the second device transmits in the network a discovery request of a UPnP protocol that specifies a service type corresponding to the device-information providing service, by sending information related to the device-information providing service to the second device via the network; and sending, when the second device sends in the network an information demanding request for demanding the attribute information of the first device, attribute information of the first device that has been stored beforehand in the storage unit to the second device.

According to still another aspect of the present invention, a method by which an information processing unit discovers presence of a first device, wherein the information processing unit and the first device being connected to one network, includes the information processing unit transmitting a discovery request of a UPnP protocol via the network and discovering a UPnP service having attribute information including device description and service description of the first device; and the information processing unit sending an attribute-information demanding request for demanding the attribute information of the first device to the UPnP service discovered at the discovering.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an example of configuration of a UPnP network according to an embodiment of the present invention;

FIG. 2 is a schematic for explaining a device discovering method according to the embodiment;

FIG. 3 is a functional block diagram of an information processing unit shown in FIG. 1;

FIG. 4 is a functional block diagram of an information providing unit shown in FIG. 1;

FIG. 5 is an example of data structure of an attribute information DB shown in FIG. 4;

FIG. 6 is a flowchart of a processing procedure performed by the information providing unit;

FIG. 7 is a flowchart of an attribute information updating process shown in FIG. 6;

FIG. 8 is an example of configuration of a UPnP network according to another embodiment of the present invention;

FIG. 9 is an example of configuration of a conventional UPnP network; and

FIG. 10 is a schematic for explaining a device discovering method employed in the conventional UPnP network shown in FIG. 9.

### DETAILED DESCRIPTION OF THE PREFERRED EMBODIMENTS

Exemplary embodiments of the present invention are explained below in detail with reference to the accompanying drawings.

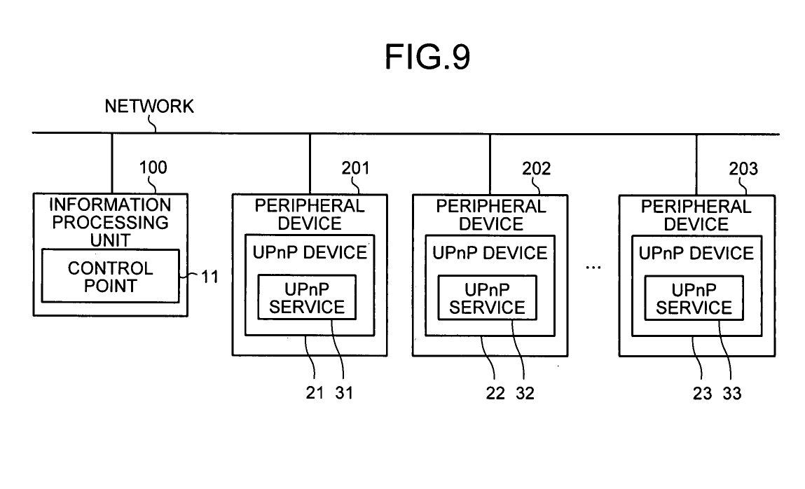

To begin with, a device discovering method employed in the conventional UPnP networks will be explained. FIG. 9 is an example of configuration of a conventional UPnP network. In the conventional UPnP network, an information processing unit 100 and a plurality of peripheral devices 201 to 203 are connected to one network.

The information processing unit 100 is a general information processing unit, such as a personal computer, and includes a control point 11. The control point 11 is a constituent element of the UPnP and has a role of discovering a device in the network and controlling the discovered device.

The peripheral device 201 can be a printer or a router, and includes a UPnP device 21. The UPnP device 21 is a constituent element of the UPnP and has a role of providing information concerning the peripheral device 201 to other devices. The information is referred to as device description and includes device type prespecified for each type of the device.

The UPnP device 21 functions as a container of a UPnP service 31 to provide information concerning the UPnP service 31 to other devices. This information is referred to as service description and includes service type prespecified for each type of the service. The UPnP device 21 is shown to function as a container of only one UPnP service 31; however, it can function as a container of a plurality of UPnP services.

The UPnP service 31 is a constituent element of the UPnP and has a role of providing information concerning the service provided by the peripheral device 201 to other devices. The information provided by the UPnP service 31 includes static information, such as the service type, and a dynamic value such as a state variable indicating the state of the service. The UPnP service 31 also has a role of receiving a request for execution of an action prepared in advance from another device and executing the action.

Similarly, the peripheral device 202 is a printer or a router, and includes a UPnP device 22. The UPnP device 22 includes a UPnP service 32. Similarly, the peripheral device 203 can be a printer or a router, and includes a UPnP device 23. The UPnP device 23 includes a UPnP service 33.

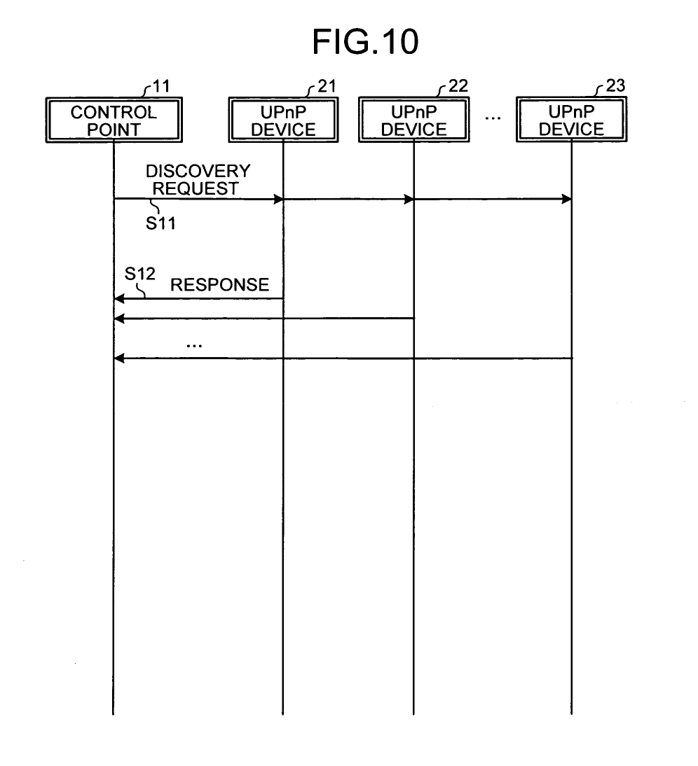

A processing procedure performed by the information processing unit 100 to discover a device in the network is explained below. FIG. 10 is schematic for explaining a device discovering method performed by the information processing unit 100 to discover a device in the network.

To discover a device, the control point 11 in the information processing unit 100 transmits a discovery request by employing the technique of multicast (step S11). The discovery request is a message that requests a response from all of the UPnP devices or all of the UPnP services in the network.

The UPnP devices 21 to 23 and the UPnP services 31 to 33 in the peripheral devices 201 to 203 receive the discovery request and each of them decides whether the UPnP device or the UPnP service satisfies the condition set in the discovery request, and if the UPnP device or the UPnP service satisfies the condition, the UPnP device or the UPnP service returns a response individually by employing the technique of unicast (step S12).

The control point 11 receives the response thereby discovering presence of a UPnP device or a UPnP service in the network that satisfies the condition set in the discovery request.

Conventionally, it is possible for the control point 11 to set or not to set a condition in the discovery request. The number of device responding to the discovery request can be limited by setting a condition; because, when a device type or a service type is set in the discovery request, only UPnP devices or UPnP services having the set device type or the service type will return a response.

However, in a large-scale network, even if the device type or the service type is set in the discovery request, responses may possibly be returned from a lot of devices, and the responses put a heavy load on the network and the control point.

In other words, the conventional device discovering method is useful in that the information processing unit can automatically discover UPnP devices or UPnP services on the network; however, it has a drawback of increasing traffic in the network.

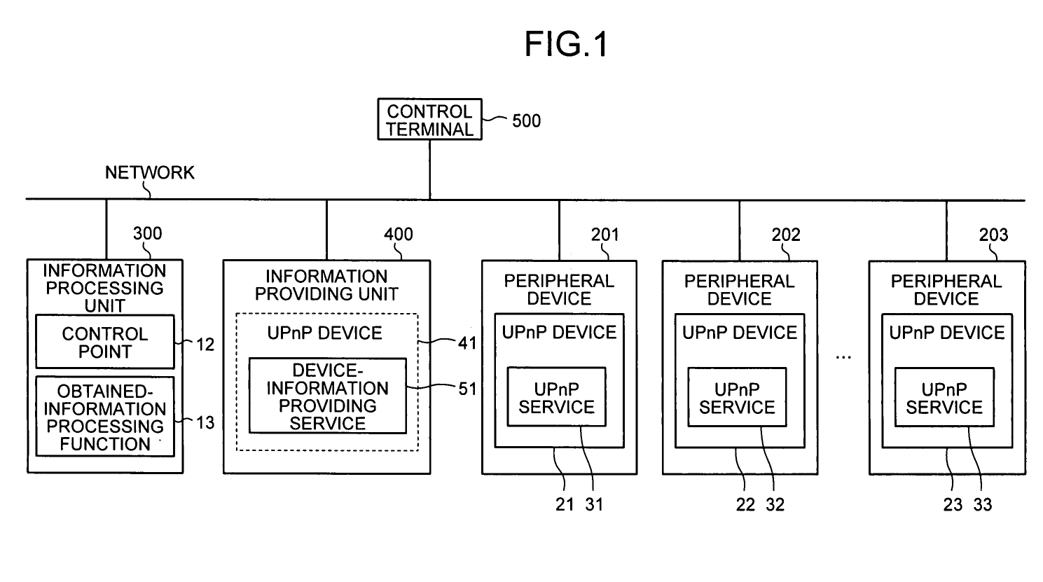

A device discovering method according to an embodiment solves the drawback of the conventional technique. FIG. 1 is an example of configuration of a UPnP network according to the embodiment. In the UPnP network, an information processing unit 300, the peripheral devices 201 to 203, an information providing unit 400, and a control terminal 500 are connected to one network. The peripheral devices 201 to 203 have the same or similar configurations or they perform the same or similar functions as the peripheral devices 201 to 203 shown in FIG. 9.

The information processing unit 300 is, for example, a personal computer, and includes a control point 12 and an obtained-information processing function 13. The control point 12 has the same role as that of the control point 11 shown in FIG. 9. The obtained-information processing function 13 has a role of processing information obtained from a device, such as a UPnP device, connected to the network.

In the conventional UPnP network, the peripheral devices 201 to 203 would perform discovery of a device on the network. On the contrary, in the UPnP network according to the embodiment, the information providing unit 400 performs the discovery of a device. The information providing unit 400 includes a dummy UPnP device. The UPnP device 41 includes a device-information providing service 51 with a unique service type.

The information providing unit 400 stores therein attribute information (not shown) relating to the peripheral devices 201 to 202. The control terminal 500, which is a terminal unit for performing network control, can be configured to input the attribute information. The attribute information is information such as device description of the UPnP devices 21 to 23 and service description of the UPnP service 31 to 33. The device-information providing service 51, upon receiving an information demanding request that includes an extraction condition, from the control point 12, returns the attribute information extracted based on the extraction condition to the control point 12.

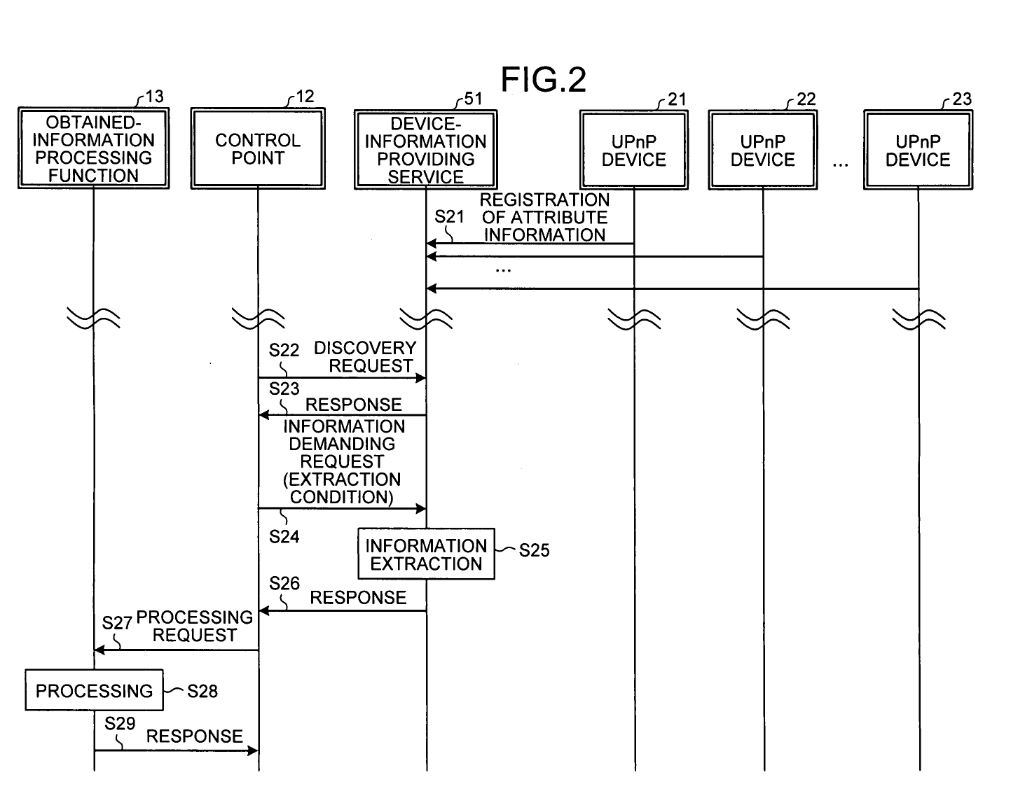

A processing procedure performed by the information processing unit 300 to discover a device on the UPnP network is explained below. FIG. 2 is a schematic for explaining a device discovering method employed by the information processing unit 300 to discover a device on the UPnP network.

First, attribute information of each of the UPnP devices 21 to 23 and the UPnP services 31 to 33 is registered in advance in the device-information providing service 51 of the information providing unit 400 (step S21).

To discover a device on the UPnP network, the control point 12 multicasts a discovery request that includes a service type of the device-information providing service 51 (step S22). Because the service type, which is unique to the device-information providing service 51, has been set in the discovery request, only the device-information providing service 51 returns a response to the control point 12 (step S23).

When the control point 12 receives the response from the device-information providing service 51, i.e., when the control point 12 “discovers” the device-information providing service 51 on the network, it transmits an information demanding request that demands information relating to other devices present on the network to the device-information providing service 51 (step S24). The information demanding request may include an extraction condition to limit the target of discovery.

The information demanding request to the device-information providing service 51 is one of the actions for remotely controlling the device-information providing service 51, and is designed so that the extraction condition can be freely set. By setting the extraction condition, the control point 12 can narrow down the device as the target of discovery. The extraction condition can includes the device type, the service type, and/or some other conditions.

Upon receipt of the information demanding request, the device-information providing service 51 extracts the information such as the device description based on the extraction condition included in the information demanding request (step S25), and responds to the control point 12 by sending the result of extraction (step S26).

The control point 12, can request the obtained-information processing function 13 to process the result of extraction based on a predetermined method (step S27). The obtained-information processing function 13 processes the result of extraction based on the predetermined method (step S28) and responds to the control point 12 by sending the result of processing.

Once the control point 12 discovers a desired device, it can execute necessary processing based on the obtained device description and service description. Once the control point 12 discovers a desired device, the device-information providing service 51 does not come in picture; because, the control point 12 and the discovered device directly communicate each other.

In this way, the control point 12 can freely set the extraction condition and narrow down the devices as the target of discovery. This reduces the traffic in the network.

Moreover, a new UPnP service can be easily added to the device-information providing service 51 without making any change to the existing UPnP device and UPnP service.

The UPnP network shown in FIG. 1 is an example but the UPnP network may include any number of each device including the information providing unit 400. Also, the type of the network does not depend on a specific network but may be any type of network as long as the UPnP can be applied to the network. The information providing unit 400 also does not have to be a stand-alone unit but may be combined with another device.

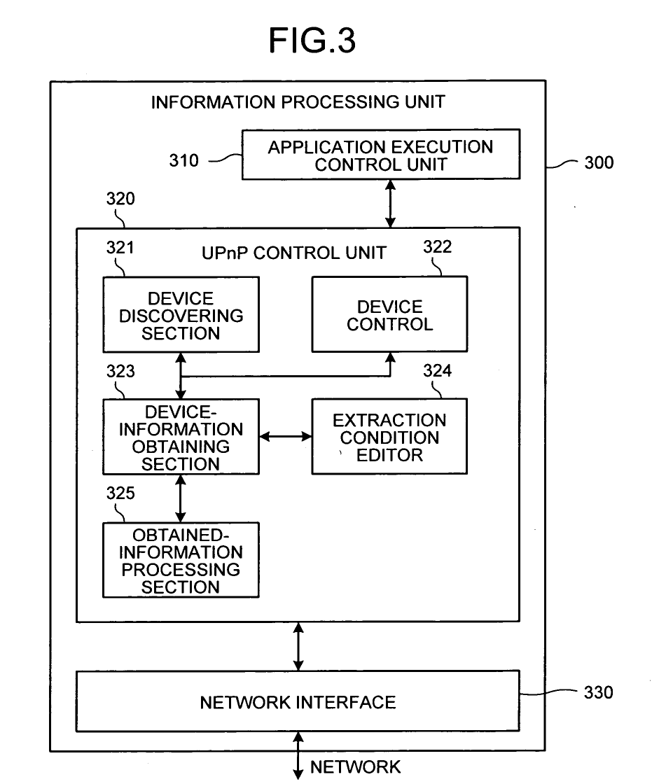

Next, configurations of the information processing unit 300 and the information providing unit 400 are explained below. FIG. 3 is a functional block diagram of the information processing unit 300. The figure illustrates only the configuration that relates to the UPnP.

As shown in FIG. 3, the information processing unit 300 includes an application execution control unit 310, a UPnP control unit 320, and a network interface 330. The network interface 330 is an interface for exchange information via the network.

The application-execution control unit 310 controls execution of various applications, and orders execution of discovery of a device present on the network, control of the discovered device, and the like to the UPnP control unit 320.

The UPnP control unit 320 executes various controls related to the UPnP and realizes functions of the control point 12 and the obtained-information processing function 13. The UPnP control unit 320 includes a device discovering section 321, a device control section 322, a device-information obtaining section 323, an extraction condition editor 324, and an obtained-information processing section 325.

The device discovering section 321 discovers a device present on the network by issuing a discovery request. The device control section 322 executes various controls on the discovered device.

The device-information obtaining section 323 obtains information related to the device present on the network by communicating with the device-information providing service 51. Upon receipt of the order of discovery of the device present on the network from the application execution control unit 310, the device-information obtaining section 323 causes the extraction condition editor 324 to edit the extraction condition corresponding to the order.

Subsequently, the device-information obtaining section 323 causes the device discovering section 321 to discover the device-information providing service 51, and orders the device control section 322 to issue an information demanding request including the extraction condition to the discovered device-information providing service 51. The device-information obtaining section 323, if necessary, causes the obtained-information processing section 325 to process the obtained information.

The extraction condition editor 324 edits the extraction condition according to the order from the device-information obtaining section 323. The obtained-information processing section 325 processes the information obtained by the device-information obtaining section 323.

The obtained-information processing section 325 can be configured to execute processings executable only on the side of the control point 12 such as extracting only the top three pieces when the obtained information is rearranged using a prespecified item as the key. Alternatively, the obtained-information processing section 325 can be configured to execute a part or all of the information extraction based on the extraction condition instead of the device-information providing service 51 to allow more flexibility to the extraction processing.

The function of the UPnP control unit 320 can be achieved by executing a UPnP control program prepared in advance. The UPnP control program is stored in a storage unit (not shown) in the information processing unit 300. The storage unit can be a hard disc, a recording medium that can be read by the information processing unit 300 like a CD-ROM, a server connected to the information processing unit 300 via the network, or the like.

A processor (not shown) in the information processing unit 300 reads the UPnP control program when the information processing unit 300 is boot, develops the UPnP control program into a memory (not shown) so that the UPnP control program can be executed, and executes the UPnP control program to realize the functions of the UPnP control unit 320. The UPnP control program can be a stand-alone program, or the entire UPnP control program or a part of the UPnP control program can be included in an operating system or a library.

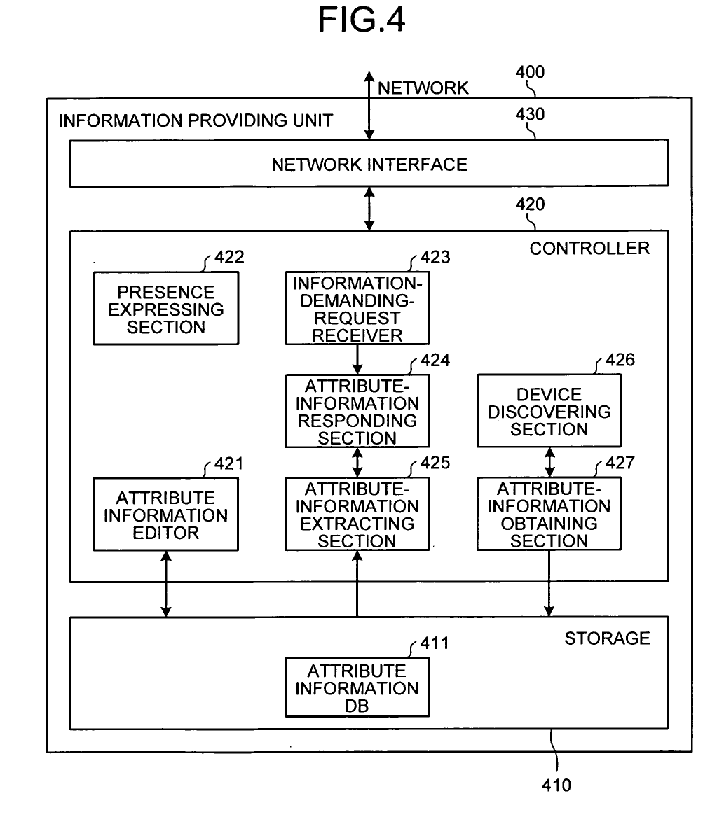

FIG. 4 is a functional block diagram of the information providing unit 400. The information providing unit 400 includes a storage 410, a controller 420, and a network interface 430. The network interface 430 is an interface for exchanging information via the network.

The storage 410 stores therein various information as well as an attribute information DB 411. The attribute information DB 411 includes information such as the device description and the service description of various devices on the network.

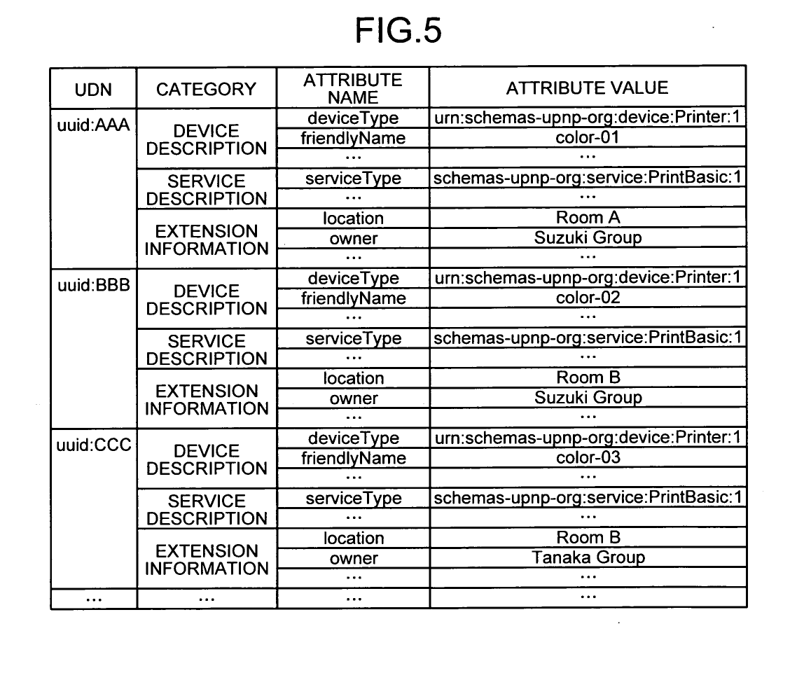

FIG. 5 is an example of data structure of the attribute information DB 411. The attribute information DB 411 includes, but not limited to, for each device, information related to a plurality of devices, and each device is identified by a unique device name (UDC) that is unique to the device, the device description, the service description, and extension information.

The device description is one of the attribute information of the UPnP device contained in the device, and specifically includes a parameter deviceType that indicates the type of the UPnP device. The service description is one of the attribute information of the UPnP service contained in the UPnP device, and specifically includes a parameter serviceType indicating the type of the UPnP service.

The extension information is one of the attribute information, and specifically includes information that is useful in practical use. The content of the device description and the service description is set by a developer of the UPnP device or the UPnP service, and is difficult for a user to add on his own. Therefore, such information that cannot be included in the device description and the service description but necessary for practical use is stored as the extension information.

In the example shown in FIG. 5, information indicative of a location and an owner of the device are stored as the extension information. The extension information is useful as the extraction information for narrowing down the target of discovery of the device. In other words, when the device description and the service description do not include any item that is desired to be used as the extraction condition, it is possible to narrow down using the item by adding the item to the extension information.

The controller 420 controls the information providing unit 400 in general and realizes the function of the device-information providing service 51. The controller 420 includes an attribute information editor 421, a presence expressing section 422, an information-demanding-request receiver 423, an attribute-information responding section 424, an attribute-information extracting section 425, a device discovering section 426, and an attribute-information obtaining section 427.

The attribute information editor 421 registers and updates information in the attribute information DB according to the order transmitted from the control terminal 500 operated by an administrator and the like. The presence expressing section 422 reports presence of the device-information providing service 51 in response to the multicast discovery request.

The information-demanding-request receiver 423 receives and passes the information demanding request to the attribute-information responding section 424. The attribute-information responding section 424 transmits the attribute information to the requestor in response to the information demanding request. More specifically, the attribute-information responding section 424 passes the extraction condition included in the information demanding request to the attribute-information extracting section 425 to have the information applicable to the extraction condition extracted from the attribute information DB 411 and to return the extracted information to the requester.

The attribute-information extracting section 425 extracts the attribute information from the attribute information DB 411 according to the extraction condition received from the attribute-information responding section 424. The attribute-information extracting section 425 can set a plurality of items in the extraction condition such as:

location=“Room B” AND owner=“Suzuki Group”.

By setting items in this manner, the target of discovery can be limited as desired.

The device discovering section 426 and the attribute-information obtaining section 427 regularly and automatically update the attribute information DB 411. When a new device is connected to the network, or the setup of a device appended to the network is changed, the contents of the attribute information DB 411 need to be updated. An approach is possible in which the administrator manually updates the contents of the attribute information DB 411; however, this approach has drawbacks such as a burden is put on the administrator, the administrator can make errors, the update may be delayed when the administrator is on leave or when he/she is busy and the like.

To take care of those drawbacks, a configuration is adopted here in which the device discovering section 426 and the attribute-information obtaining section 427 automatically update the attribute information DB 411. Automatic updating of the attribute information DB 411 can be performed in various ways. For example, the device discovering section 426 can multicast the discovery request regularly to discover devices in the network, and the attribute-information obtaining section 427 can obtain the device description and the service description of the device discovered by the device discovering section and update the attribute information DB 411 based on the obtained information.

By automatically updating the attribute information DB 411, the burden on the administrator can be reduced, and the attribute information DB 411 can be updated in substantially real-time.

The function of the controller 420 can be also achieved by executing an information providing program prepared in advance on an information processing unit including a processor and a memory. The information providing program can be stored in a storage unit, equipped in the information processing unit, such as a hard disc, a recording medium that can be read by the information processing unit like a CD-ROM, a server connected to the information processing unit via the network, or the like.

The processor reads the information providing program when the information processing unit is boot, develops the information providing program into the memory so that the information providing program can be executed, and executes the information providing program to realize the functions of the controller 420.

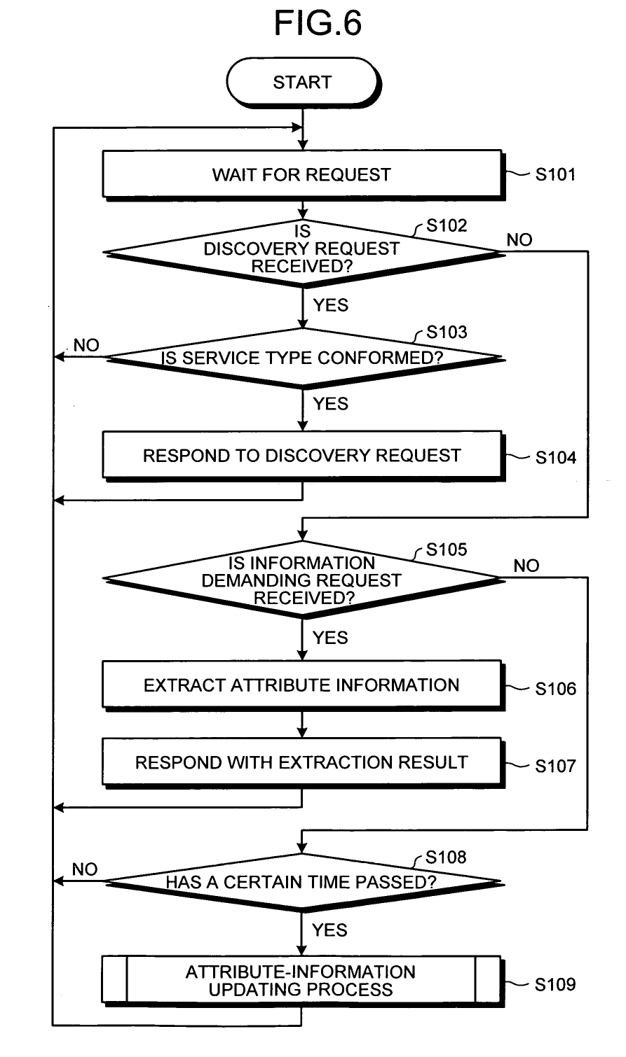

FIG. 6 is a flowchart of a processing procedure performed by the information providing unit 400. In the beginning, the information providing unit 400 waits for a request from the control point 12 (step S101). When the information providing unit 400 receives a discovery request (step S102, YES), and when a service type of the device-information providing service 51 has been set in the discovery request (step S103, YES), the presence expressing section 422 reports the presence of the device-information providing service 51 to the requestor as a response to the discovery request (step S104). Subsequently, the system control returns to step S101 to wait for the next request.

Although the discovery request is received, if a service type of the device-information providing service 51 has not been set in the discovery request (step S103, NO), the system control returns to step S101 to wait for the next request.

When an information demanding request is received (step S102, NO, step S105, YES), the attribute-information extracting section 425 extracts attribute information from the attribute information DB 411 based on an extraction condition included in the information demanding request (step S106), and the attribute-information responding section 424 sends the result of extraction to the requestor as a response to the information demanding request (step S107). Subsequently, the system control returns to step S101 to wait for the next request.

When neither a discovery request nor an information demanding request is received (step S102, NO, step S105, NO), if a certain time has passed since the last execution of the attribute information updating processing (step S108, YES), an attribute information updating process is executed (step S109). Subsequently, the system control returns to step S101 to wait for the next request. If the certain time has not passed (step S108, NO), the state of waiting for the next request continues.

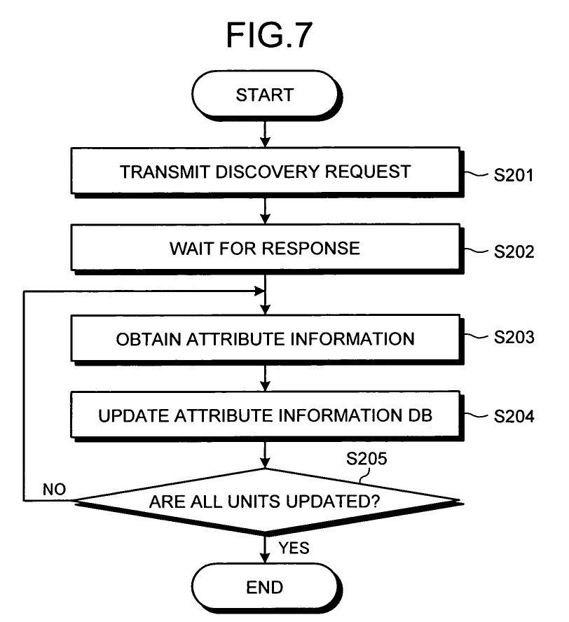

FIG. 7 is a detailed flowchart of the attribute information updating process shown in FIG. 6.

In the beginning, the device discovering section 426 multicasts a discovery request (step S201) and waits for a response (step S202). When the attribute-information obtaining section 427 obtains attribute information from a device in response to the discovery request sent by the device discovering section 426 (step S203), the attribute-information obtaining section 427 reflects the obtained attribute information on the attribute information DB 411 (step S204). If the obtaining of attribute information of all the devices discovered in the network and the updating of the attribute information DB 411 with the obtained attribute information have not been completed (step S205, NO), steps S203 and S204 are executed repeatedly.

As described above, according to the embodiment, an extraction condition can be set. When the extraction condition is set, it becomes possible to narrow down the discovery target devices existing on a network.

It can be difficult to update the information stored in the attribute information DB 411 in real-time; because, there is a time lag from when a new device is connected to the network until the information processing unit 300 discovers the device.

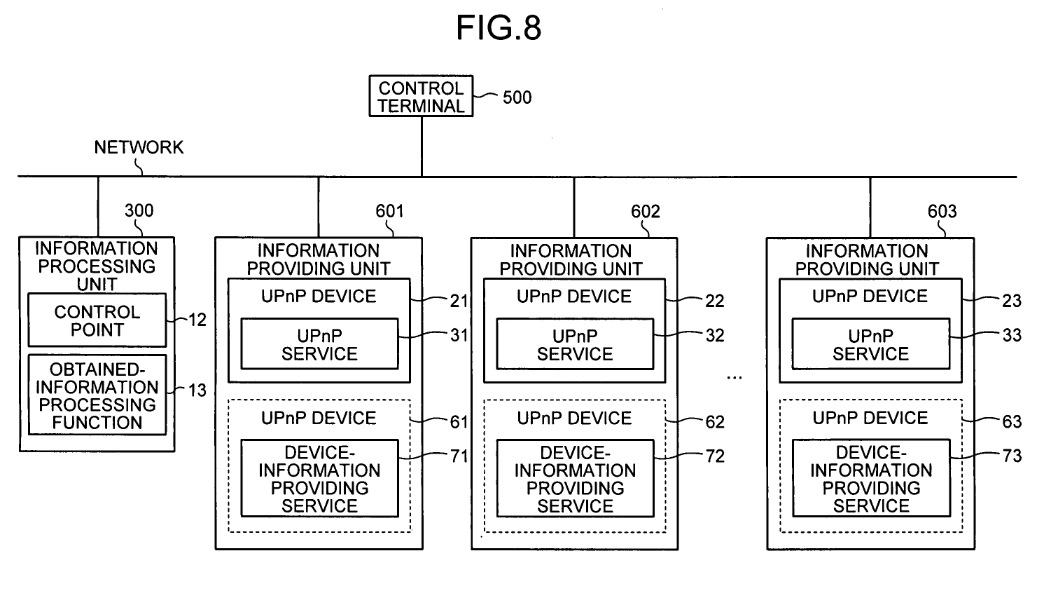

When real-timeliness is desirable, one approach is to provide a device information providing service in each device connected to the network. FIG. 8 is an example of configuration of a UPnP network according to another embodiment of the present invention. In the UPnP network shown in FIG. 8, the information processing unit 300, peripheral devices 601 to 603, and the control terminal 500 are connected to one network. The information processing unit 300 and the control terminal 500 are identical to the information processing unit 300 and the control terminal 500 shown in FIG. 1, respectively.

The peripheral device 601 is a printer or a router, and includes a UPnP device 61 including a device-information providing service 71 in addition to the UPnP device 21 including the UPnP service 31 corresponding to the primary service of the unit.

Upon receipt of an information demanding request including a prespecified extraction condition from the control point 12, like the device-information providing service 51, the device-information providing service 71 responds with the attribute information extracted based on the extraction condition. The attribute information to be extracted here may be the device description of the UPnP device 21 and the service description of the UPnP service included in the unit.

Similarly, the peripheral device 602 is a printer or a router, and includes a UPnP device 62 including a device-information providing service 72 in addition to the UPnP device 22 including the UPnP service 32 corresponding to the primary service of the unit.

The peripheral device 603 is a printer or a router, and includes a UPnP device 63 including a device-information providing service 73 in addition to the UPnP device 23 including the UPnP service 33 corresponding to the primary service of the unit.

In the UPnP network, the control point 12 discovers the device-information providing services 71 to 73 included in each unit in response to the discovery request, and transmits the information demanding request to the device-information providing services 71 to 73 individually to obtain information of the desired device. It is also possible to include the extraction condition in the information demanding request to narrow down the device to be discovered.

Since this configuration does not need to register the attribute information of the device appended to the network in the information providing unit 400 like the configuration shown in FIG. 1, when a new device is appended to the network, the control point 12 can obtain the attribute information of the device immediately.

It is also possible to combine the configurations shown in FIG. 1 and FIG. 8 such that the device-information providing service is provided individually to a part of the device appended to the network and that the attribute information of other devices is intensively controlled by the information providing unit 400.

Since an embodiment of the present invention is configured to realize the device-information providing service as the UPnP service and to provide the information processing unit with information necessary for the information providing service to discover the device appended to the network, it is possible to define a procedure of discovering the device appended to the network as a spec of the device-information providing service advantageously allowing flexibility to the procedure of discovering the device appended to the network without significantly changing the mechanism of the UPnP.

Moreover, since an embodiment of the present invention is configured so that the device-information providing service responds to the information processing unit with the attribute information including the device description and service description of the device appended to the network, the information processing unit can advantageously execute various controls on the device corresponding to the attribute information responded from the device-information providing service without reissuing the discovery request.

Furthermore, since an embodiment of the present invention is configured so that the device-information providing service responds to the information processing unit with the attribute information extracted based on the specified extraction conditions, it is possible to define the extraction condition for narrowing down the target of discovery as a spec of the device-information providing service, advantageously allowing flexibility to the procedure of discovering the device appended to the network without significantly changing the mechanism of the UPnP.

Furthermore, since an embodiment of the present invention is configured so that the device-information providing service transmits the discovery request to discover an device appended to the network and obtain the device description and service description of the discovered device to update the information stored in itself, there is an advantage of automating maintenance of the attribute information stored in the device-information providing service to reduce the operating cost.

Furthermore, since an embodiment of the present invention is configured to provide a UPnP service of obtaining attribute information including the device description and the service description of the device appended to the network so that the UPnP service provides the information processing unit with the information necessary to discover the device appended to the network, it is possible to define the procedure of discovering the device appended to the network as a spec of the UPnP service advantageously allowing flexibility to the procedure of discovering the device appended to the network without significantly changing the mechanism of the UPnP.

Moreover, since an embodiment of the present invention is configured so that the UPnP service responds to the information processing unit with the attribute information extracted based on the specified extraction condition, it is possible to define the extraction condition for narrowing down the target of discovery as a spec of the UPnP service advantageously allowing flexibility to the procedure of discovering the device appended to the network without significantly changing the mechanism of the UPnP.

Furthermore, since an embodiment of the present invention is configured so that the UPnP service transmits the discovery request to discover an device appended to the network and obtain the device description and service description of the discovered device to update the information stored in itself, there is an advantage of automating maintenance of the attribute information stored in the UPnP service to reduce the operating post.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing device that realizes a device-information providing service of providing, as a UPnP service, attribute information of a first device to a second device, wherein the information providing device, the first device, and the second device being connected to one network, the information providing device comprising:
a storage unit that stores therein the attribute information of the first device;
a presence expressing unit that, when the second device transmits in the network a discovery request of a UPnP protocol that specifies a service type corresponding to the device-information providing service, reports presence of the information processing device in the network by sending information related to the device-information providing service to the second device via the network; and
an attribute-information sending unit that, when the second device sends in the network an information demanding request for demanding the attribute information of the first device, sends the attribute information of the first device in the storage unit to the second device.

2. The information providing device according to claim 1, wherein the attribute information includes device description and service description of the first device.

3. The information providing device according to claim 1, wherein the first devices are provided in plurality, the storage unit stores therein attribute information of each of the first devices, and the information demanding request includes an extraction condition,
the information providing device further comprising an attribute-information extracting unit that extracts attribute information based on the extraction condition in the information demanding request from the storage unit, wherein
the attribute-information sending unit sends the attribute information extracted by the attribute-information extracting unit to the second device.

4. The information providing device according to claim 1, further comprising:
a device discovering unit that transmits a discovery request of the UPnP protocol via the network and discovers the first device that responds to the discovery request; and
an attribute-information obtaining unit that requests the first device discovered by the device discovering unit to send device description and service description and stores device description and service description received from the first device as the attribute information in the storage unit.

5. A computer-readable recording medium that stores therein a computer program that causes an information providing device to realizes a device-information providing service of providing, as a UPnP service, attribute information of a first device to a second device, wherein the information providing device, the first device, and the second device being connected to one network, the computer program causing the information providing device to execute:
reporting presence of the information processing device in the network, when the second device transmits in the network a discovery request of a UPnP protocol that specifies a service type corresponding to the device-information providing service, by sending information related to the device-information providing service to the second device via the network; and
sending, when the second device sends in the network an information demanding request for demanding the attribute information of the first device, attribute information of the first device that has been stored beforehand in the storage unit to the second device.

6. The computer-readable recording medium according to claim 5, wherein the attribute information includes device description and service description of the first device.

7. The computer-readable recording medium according to claim 5, wherein the first devices are provided in plurality, the storage unit stores therein attribute information of each of the first devices, and the information demanding request includes an extraction condition,
the computer program further causes the information providing device to execute extracting attribute information based on the extraction condition in the information demanding request from the storage unit, wherein
the sending includes sending the attribute information extracted at the extracting to the second device.

8. The computer-readable recording medium according to claim 5, the computer program further causes the information providing device to execute:
transmitting a discovery request of the UPnP protocol via the network and discovering the first device that responds to the discovery request; and
requesting the first device discovered at the discovering to send device description and service description and storing device description and service description received from the first device as the attribute information in the storage unit.

9. A method by which an information processing unit discovers presence of a first device, wherein the information processing unit and the first device being connected to one network, the method comprising:
the information processing unit transmitting a discovery request of a UPnP protocol via the network and discovering a UPnP service having attribute information including device description and service description of the first device; and
the information processing unit sending an attribute-information demanding request for requesting the UPnP service discovered at the discovering to provide the attribute information.

10. The method according to claim 9, wherein the attribute-information demanding request includes an extraction condition for narrowing down search of attribute information.

11. The method according to claim 9, further comprising the UPnP service transmitting a second discovery request of the UPnP protocol via the network, discovering presence of the first device in the network that responds to the second discovery request, obtaining the device description and the service description of the first device from the first device, and updating the attribute information stored therein.

12. The method according to claim 9, further comprising receiving the attribute information from the UPnP service in response to the attribute-information demanding request; and performing a predetermined processing on the attribute information.
